(19) United States
(12) Patent Application Publication
(10) Pub. No.: US 2017/0129471 A1
(43) Pub. Date: May 11, 2017

(54) BRAKE LINE BLEEDING DEVICE

(71) Applicant: Jeffry G. Holmes, Luther, MI (US)

(72) Inventor: Jeffry G. Holmes, Luther, MI (US)

(21) Appl. No.: 15/182,177

(22) Filed: Jun. 14, 2016

Related U.S. Application Data
(60) Provisional application No. 62/252,150, filed on Nov. 6, 2015.

(51) Int. Cl. B60T 17/22

(52) U.S. Cl. CPC B60T 17/223

(57) ABSTRACT

A device for reciprocally actuating a vehicle brake pedal in first and second directions for the purpose of bleeding its brake lines. A cylinder includes a fluid displaceable and length adjustable shaft extending therefrom, a clamp extending from the cylinder and adapted to securing to a steering wheel associated with the vehicle. A bracket extends from a remote extending end of the shaft and is adapted to mount to the vehicle brake pedal. A pair of fluid lines extends to first and second locations along the cylinder and a pressurized fluid source is selectively communicated with one of the lines in order to alternately depress and retract the brake pedal.

### CROSS REFERENCE TO RELATED APPLICATIONS

The present application claims the priority of U.S. Ser. No. 62/252,150, filed Nov. 6, 2015, the contents of which are incorporated herein in its entirety.

### FIELD OF THE INVENTION

The present invention discloses a brake line bleeding device capable of being utilized by a single person remotely from outside the vehicle. The device includes a main body with a cylinder and adjustable stem which is attached between the steering wheel and the brake pedal. A pair of hoses extend from opposite end locations of the cylinder and can optionally include pressure regulators at the cylinder in combination with intermediate quick connector attachments. The hoses attach to a foot pedal and, with the use of a pressurized tank or compressor which is likewise attached to a separate input associated with the foot pedal or other triggering device, provides for a pressurized input for driving the cylinder, sleeve and brake pedal attachment.

### BACKGROUND OF THE INVENTION

The prior art is documented with numerous examples of brake pedal actuator (bleeding devices) the purpose for which being the ability of a single user to bleed a vehicles brakes from a location outside of the vehicle. Among these are included the patent references to Rhodenizer, U.S. Pat. No. 6,131,712, Campbell, US 2008/0011566, Youngers, U.S. Pat. No. 5,299,668, Hare, U.S. Pat. No. 6,044,671, and Whitt, US 2007/0012533.

Typical of the prior art is the brake pedal actuator of Rhodenizer which teaches a brake pedal actuator having a tubular member and a stem telescopically mounted in the tubular member. A J-shaped hook is mounted on the stern for attachment to a segment of a steering wheel of a vehicle. A pedal clamping mechanism is mounted on the tubular member for attachment to the brake pedal of the vehicle. A handle is mounted on the tubular member for allowing a manual pushing and pulling of the brake pedal by a user standing outside the vehicle.

In another aspect of the invention, the actuator in Rhodenizer has a wedge-type locking sleeve and nut affixed to the clamping mechanism for selectively locking the mechanism and for preventing a loosening or clapping of the latching mechanism when the brake pedal is manually actuated back and forth. In a further aspect of the present invention, the brake pedal actuator comprises a ring which is movably mounted on the stem and restrictively positional along the stem. When the brake pedal actuator is in use in a still mode, the position of the ring and the end of the tubular member are usable for monitoring a creeping movement of a brake pedal under a load from the actuator.

Additional to the Rhodenizer U.S. Pat. No. 6,131,712 reference, the other cited references are all of a similar nature (all within the same class and subclass and all directed to a brake bleeding device which attaches between a pedal and some interior location of the vehicle. Among these, Youngers teaches a supply line 22 and attachment fitting 23 engageable with a pressurized source (tank, compressor) which drives the actuator 10 hooked between the steering wheel and break pedal via an intermediate pressure control assembly 24.

Finally, the commercial disclosure for the Pedal Pumper is noted and appears similar to the Youngers patent with an expansible cylinder attached between the vehicle steering wheel and the brake pedal, a fluid line extending from a pressurized input location of the cylinder to a remote location (presumably again compressor or the like).

### SUMMARY OF THE INVENTION

As previously described, the present invention discloses a brake line bleeding device capable of being utilized by a single person remotely from outside the vehicle. The device includes a main body with a bi-directionally driven cylinder and adjustable stem which is attached between the steering wheel and the brake pedal. The stem further includes an air (or other suitable fluidic medium) cylinder shaft extending from the air cylinder, a further length adjustable sleeve extending from the shaft and terminating in an end shaft to which is mounted a bracket for securing to the brake pedal.

A pair of hoses extend from opposite attachment end locations of the cylinder, these optionally including pressure regulators such as which may be located at the cylinder connection. The hoses may further include intermediate quick connector attachments to which a remote pressurized source is engaged so that, in use, the hoses are alternately pressurized and actuated in order to drive the stern in either of bi-directional fashion in order to both depress the brake pedal, as well as to subsequently retract or pull the brake pedal in an opposite direction toward the steering wheel.

The ability to push/pull the brake pedal in this fashion contributes to faster effective bleeding of the brakes, and as opposed to a situation such as in the Prior Art in which the actuating device only pushes in a given direction in timed and sequenced fashion, with released pressure acting on the brake pedal between depressing actuation during which pedal gradually retracts as a result of the internal counter pressures within the brake line acting upon it.

In one non-limiting application, the hoses attach to a foot pedal and, with the use of the pressurized tank or compressor which can be attached to a further input associated with the foot pedal, provide for delivering the pressurized input for driving the cylinder, sleeve and brake pedal attachment. In a further use application, the reverse/pulling aspect of the device can create sufficient holding forces between the steering wheel and brake pedal, such holding the wheel in place and preventing inadvertent rotation thereof during straightening the front end of the vehicle.

### BRIEF DESCRIPTION OF THE DRAWINGS

Reference will now be made to the attached drawing, when read in combination ith the following detailed description, wherein like reference numerals refer to like parts throughout the several views, and in which:

FIG. 1 is an environmental view illustrating the pedestal attachment device in use with a vehicle having its brake lines bled; and

FIG. 2 is an overall view of the pedal attachment device according to the present invention.

### DETAILED DESCRIPTION OF THE PREFERRED EMBODIMENTS

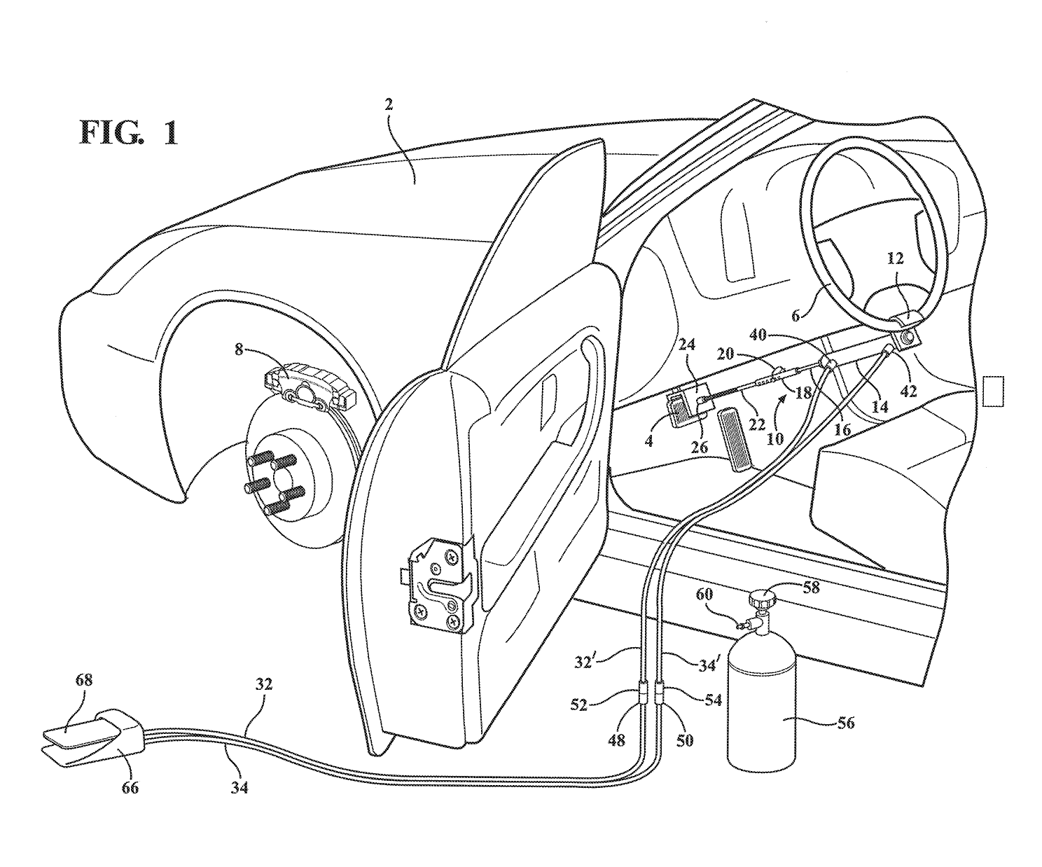

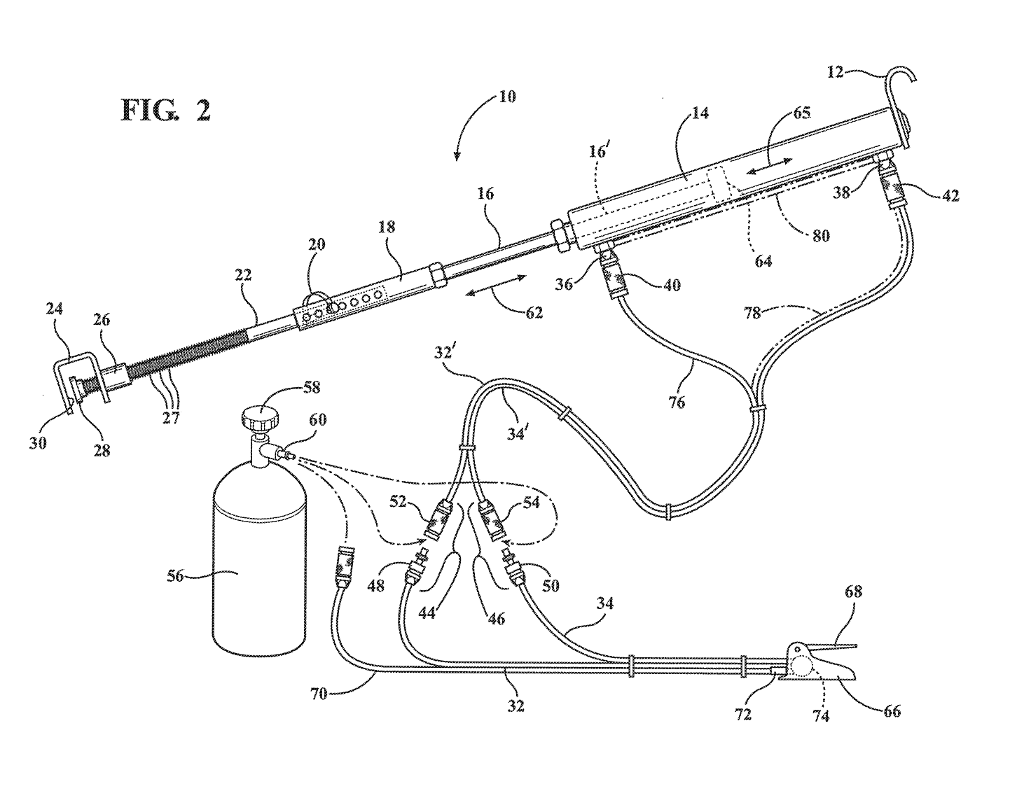

Referring to FIGS. 1 and 2, the present invention discloses a brake line bleeding device, see generally at 10, which is capable of being utilized by a single person remotely from outside a vehicle, represented at 2 in FIG. 1, with which the device is utilized. As will be further described, the present invention is an improvement over prior art brake bleeding devices in that it provides for improved bi-directional driving motion of the cylinder stem an associated linkages for the purpose of remotely and repetitively depressing and releasing the brake pedal, further at 4 in FIG. 1, in order to bleed the vehicle brakes during servicing by a single individual operating on the vehicle at a location remote from its interior (e.g. underneath the vehicle in proximity to the brake lines and in order to facilitate draining of the fluid).

With additional reference to FIG. 2, the device 10 includes a main elongated and length extensible body which is secured between the vehicle steering wheel, further at 6 in FIG. 1 by an arcuate shaped hook 12 which is secured to a first end of the device, and the brake pedal 4. The main attachable body is further defined as including each of a pressurized (air) cylinder 14, and air cylinder shaft 16 (projecting from the cylinder 14), a length adjustable sleeve 18 with locking pin 20 secured to an end of the shaft 16, and an end extending shaft 22 which in turn supports such as a brake pedal engaging portion, such including any of a “U” shaped brake pedal mounted bracket 24, a otherwise configured portion which can be similar to the steering wheel engaged hook and which is secured to the end of the stem linearly displaceable stem and is adapted to being engaged to the vehicle brake pedal 4 in the manner to be described.

As previously indicated, the steering wheel clamp 12 is shown and which extends from a first (proximal) end of the cylinder 14 for mounting to the vehicle steering wheel 6 by engaging a wheel location against its inner contoured side. At the opposite end, the “U” shaped brake pedal mounted bracket or hook 24 includes an interiorly collar mount, see at 26 which is secured to the bracket 24, and through which is linearly received the end most exteriorly threaded and extending portion (see threads 27) of the shaft 22.

In one non-limiting variant, an end abutment 28 can be provided and includes any of a free rotating pedestal or end cap, provided upon the end face of the extended shaft 22 and so that it is threadably adjusted through the open collar mount 26 and into the interior of the “U” shaped bracket at which it comes into contact with the outer facing surface of the pedal 4. In a further variant, the “U” shaped bracket interior can be provided more generally as a hook without the open collar mount through which the stem projects, and so that the open interior “U” bracket or other hook shaped engaging member sets over the upper extending edge of the brake pedal and the linear adjusting aspects of the cylinder and sleeve provide the necessary travel motion of the bracket 24 into push/pull bi-directionally actuating contact with the brake pedal.

In use, and upon removing the locking pin 20 and readjusting the non-threaded and linearly displaceable portion of the shaft 22 by realigning its length relative to the sleeve 18 (via reseating the pin 20 into length defined apertures in the sleeve 18 which may align with additional apertures configured into the shaft 22), the present invention allows for varying the overall length of the body for accommodating the given dimension between the vehicle steering wheel and its brake pedal, prior to engagement and application of the pressurized fluid source (such including any of an air/pneumatic or liquid/hydraulic), and so that the brake pedal bracket 24 is positioned for sandwiching the vehicle brake pedal between selected inner face 30 and the opposing end face of the length adjustable end abutment or cap 28. To this end, the shaft can also be locked into position relative to both the adjusting sleeve 18 as well as the collar mount 26 and it is also envisioned that other structure beyond that described herein can be provided for establishing an overall length extending stern or shaft (collectively incorporating the features depicted in non-limited fashion in the illustrations) projecting from the drive cylinder 14 in order to alternately depress and release the vehicle brake pedal.

A pair of hoses are provided, each having first and second interconnecting lengths identified at 32/34 and 32′/34′. The second length portions 32′/34′ of the hoses extend from opposite end fittings 36 and 38 associated with the cylinder 14, and which generally correspond to front and rear ends of the cylinder. As further shown, a pair of pressure regulators 40 and 42 are optionally provided located at proximate end locations of the hose portions 32′/34′ at the cylinder connections 36/38.

Intermediate quick connector attachments, see subassemblies depicted at 44 and 46 with first 48/50 and second 52/54 interconnecting attachments, are provided for interconnecting the first 32/34 and second 32′/34′ hose portions together. In one non-limiting variant, and upon separating a given pair of the quick connect 48/52 or 50/54, the given coupling portion 52 or 54 is engaged to a remote pressurized source (see pressurized tank or compressor 56 with top open/close valve 58 and nozzle outlet 60 for receiving the connector 52/54), this accomplished in alternative fashion in order to selectively pressurize a given one of the selected fluid line portions 32′ or 34′.

In this fashion, the hose portions 32′ or 34′ are alternately actuated in order to drive the stem 16 and associated end fittings in either of bi-directional fashion (arrow 62) in order to depress and subsequently release the brake pedal 4. As is further understood, and without limitation, the cylinder interior 14 can be configured with a bi-directional movable disk (shown in phantom at 64 within the channeled interior of the cylinder 14 in supported end communication with portion 16′ of the stern extending within the cylinder interior). The disk 64 can exhibit a sealed outer perimeter or the like so that corresponding bi-directional interior movement of the disk within the cylinder (see arrow 65 in FIG. 2 is accomplished by pressurized fluid (air) entering either of the subdivided chambers in the interior of the cylinder which are on opposite sides of the linearly displaceable and edge gasket sealed disk 64 and which in turn extend or retract the sleeve (see cylinder interior portion 16′ and projecting portion 16) to push or pull on the pedal 4 via the end mounted “U” bracket or hook 24.

As further shown, the first hose portions 32/34 can also extend to an end most positioned foot pedal 66 which can operate independently of or in cooperation with the pressurized tank 56 or compressor, for delivering the pressurized input for driving the cylinder, sleeve and brake pedal attachment in the manner described.

For purposes of the present invention, it is understood that the basic two way displacement operation of the cylinder 16 can be accomplished in one non-limiting application by only the second hose portions 32734′ in alternating engagement with the pressurized fluid source 56 (again via quick connect portions 52 or 54 in engagement with the nozzle 60 of the source 56 (again air tank or compressor). The foot pedal 66, with upper pivoting arm or actuating portion 68, such as is located in proximity to the brake pads 8 (FIG. 1) can be alternatively engaged to the lines in the manner depicted in FIG. 1 (such as by a single individual replacing the pads) and, upon separating a selected pair of quick connect assemblies 44 or 46 (again individual pairs of couplings 48/52 or 50/54) can operate on a foot pedal pressurizing arrangement for driving the cylinder without the need of the external pressurizing source 56.

In a further non-limiting embodiment, the pressurized fluid source 56 can alternatively or additionally include a separate line or conduit 70 which connects to the nozzle 60 at a first end and, at an opposite second end, to a separate fluid input plug or port 72 of the foot pedal 66 which is in turn in selective communication with either of (or concurrently both) the hose portions 32 or 34. In one configuration a selected pair of quick connects 48/52 or 50/54 can be separated to thereby interrupt flow through that line, resulting in pressurized flow only through the other connected line.

In a further configuration, the quick connects between hose portions 32/34 and 32′/34′ can be rendered optional (thereby rendering the pairs of interconnected hose portion as a single pair of extending hoses between the foot pedal and the cylinder), this by integrating a switch 74 integrated into the fluid communicating interior of the foot pedal 66 which selectively fluidly communicates the pressurized flow through line 70 with a selected one of the hoses 32/34.

The split mounting arrangement of the hose portions 32′/34′ in respective fashion to the opposite end ports 36/38 of the cylinder 14 can also be substituted in a further non-limiting variant by reconfiguring/removing indicated split portion 76 (FIG. 2) to extend instead as shown at 78 in bound fashion to the rear end of the cylinder 14 consistent with the positioning of the end port 38. In this alternate configuration, an elongated and linear attachment 80 extends between the cylinder end ports 36/38 (along either of the interior or exterior of the cylinder, and in order to communicate the flow from line 78 to the port 36, in this application for selective pressurized introduction into the interior of the cylinder and for retracting the sleeve 16 and pulling the pedal 4.

As previously described, the ability to push/pull the brake pedal in this fashion contributes to faster effective bleeding of the brakes, and as opposed to a situation such as in the Prior Art in which the actuating device only pushes in a given direction in timed and sequenced fashion, with released pressure acting on the brake pedal between depressing actuation during which pedal gradually retracts as a result of the internal counter pressures within the brake line acting upon it. In a further use application, the reverse/pulling aspect of the device can create sufficient holding forces between the steering wheel and brake pedal, such holding the wheel in place and preventing inadvertent rotation thereof during straightening the front end of the vehicle associated with a front end alignment operation.

Having described our invention, other and additional preferred embodiments will become apparent to those skilled in the art to which it pertains, and without deviating from the scope of the appended claims. Without limitation, this can include the reconfiguration of the cylinder and associated fluid lines for use with a hydraulic (liquid) based pressurized source and as an alternative to a pneumatic based system as described and illustrated. It is also envisioned that the attachable device can be differently shaped from that shown without departing from the scope of the inventive concept.

We claim:

1. A device for reciprocally actuating a vehicle brake pedal in alternating depress and retract fashion for the purpose of bleeding its brake lines, said device comprising:
a cylinder having a fluid displaceable and length adjustable shaft extending therefrom;
a hook extending from a first end of said cylinder and adapted to engage a steering wheel associated with the vehicle;
a bracket extending from an opposite remote extending end of said shaft and adapted to contact he brake pedal;
fluid lines extending to first and second locations along said cylinder; and
a remote pressurized fluid source selectively communicating with one of said lines in order to drive said cylinder, shaft and bracket in either of two opposite directions for alternately depressing and retracting the brake pedal.

2. The device as described in claim 1, said shaft further comprising a length adjustable sleeve with locking pin secured to an end of said shaft.

3. The device as described in claim 2, said shaft further comprising an end extending shaft secured to said sleeve, said bracket further including a “U” shaped brake pedal mounted bracket.

4. The device as described in claim 3, further comprising a collar mount integrated into said “U” shaped bracket, through which is linearly received an end most extending portion of said end extending shaft.

5. The device as described in claim 4, further comprising a freely rotatable end stop provided upon said end most extending portion of said end extending shaft, the brake pedal being sandwiched between said end stop and a selected inner face of said bracket.

6. The device as described in claim 1, said first and second locations of said cylinder further comprising end port fittings corresponding to front and rear ends of said cylinder and from which proximate end location of said fluid lines extend.

7. The device as described in claim 6, said end fittings further comprising pressure regulators.

8. The device as described in claim 1, said fluid lines further comprising intermediate quick connector attachments to which said pressurized fluid source is attached.

9. The device as described in claim 8, said pressurized fluid source further comprising at least one of a pressurized tank or compressor.

10. The device as described in claim 1, further comprising a foot pedal receiving extending ends of each of said remote pressurized fluid source and said fluid lines, depressing of said foot pedal pressurizing at least one of said fluid lines.

11. The device as described in claim 6, a selected one of said fluid lines further comprising a linear attachment to said cylinder extending between said end port fittings.

12. A device for reciprocally actuating a vehicle brake pedal in first and second directions for the purpose of bleeding its brake lines, said device comprising;
an elongated body having a hook adapted to engage a steering wheel of the vehicle at a first end and the brake pedal at a second bi-directionally extensible end;
said body incorporating a cylinder having a fluid displaceable and length adjustable shaft extending therefrom;
a bracket extending from a remote extending end of said shaft and adapted to engage the vehicle brake pedal;
a pair of fluid lines extending to first and second locations along said cylinder;
a displaceable foot pedal connecting to extending end locations of said first extending lengths of said fluid lines; and
a pressurized fluid source connecting to a further location of said foot pedal for alternatively actuating said cylinder, shaft and bracket in bi-directional fashion.

13. The device as described in claim 12, said shaft further comprising a length adjustable sleeve with locking pin secured to an end of said shaft.

14. The device as described in claim 13, said shaft further comprising an end extending shaft secured to said sleeve, said bracket further including a “U” shaped brake pedal mounted bracket.

15. The device as described in claim 14, further comprising a collar mount integrated into said “U” shaped bracket, through which is linearly received an end most extending portion of said end extending shaft.

16. The device as described in claim 15, further comprising a freely rotatable end stop provided upon said end most extending portion of said end extending shaft, the brake pedal being sandwiched between said end stop and a selected inner face of said bracket.

17. The device as described in claim 12, said first and second locations of said cylinder further comprising end fittings corresponding to front and rear ends of said cylinder and from which proximate end location of said fluid lines extend.

18. The device as described in claim 12, said pressurized fluid source further comprising at least one of a pressurized tank or compressor.

19. A reciprocally actuating elongated device secured in extending fashion between a vehicle steering wheel and a brake pedal, said device comprising:
an elongated body including a hook adapted to engage a steering wheel of the vehicle at a first end and the brake pedal at a second bi-directionally extensible end;
said body incorporating a cylinder having a fluid displaceable and length adjustable shaft extending therefrom, said shaft having first and second length adjustable and telescoping portions;
a bracket extending from a remote extending end of said shaft and adapted to mount to the vehicle brake pedal;
a pair of fluid lines communicable with first and second end proximate locations of said cylinder;
a displaceable foot pedal connecting to extending end locations of said first extending lengths of said fluid lines; and
a pressurized fluid source connecting to a further location of said foot pedal for alternatively actuating said cylinder, shaft and bracket in bi-directional fashion in order to bleed a vehicle brakes in a first application, said device being locked in a second actuated condition to fix the steering wheel to permit alignment of the vehicle front end in a second application,

20. The device as described in claim 19, said telescoping shaft portions further comprising overlapping pluralities of apertures which, upon alignment receive a pin for establishing an overall length of said body.
